(19) United States
(12) Patent Application Publication
(10) Pub. No.: US 2025/0308743 A1
(43) Pub. Date: Oct. 2, 2025

(54) EMBEDDED INDUCTION MAGNETIC COMPONENT, TRANSFORMER, AND POWER SUPPLY DEVICE

(71) Applicant: Huawei Digital Power Technologies Co., Ltd., Shenzhen (CN)

(72) Inventors: Xiaoqing HU, Dongguan (CN); Yanjun Zhi, Dongguan (CN); Xiaming Jing, Dongguan (CN)

(73) Assignee: Huawei Digital Power Technologies Co., Ltd., Shenzhen (CN)

(21) Appl. No.: 19/078,736

(22) Filed: Mar. 13, 2025

(30) Foreign Application Priority Data
Mar. 29, 2024 (CN) 202410383074.1

(51) Int. Cl. H01F 27/02; H01F 27/28; H01F 30/06

(52) U.S. Cl. CPC H01F 27/022; H01F 27/2828; H01F 27/2895; H01F 30/06

(57) ABSTRACT

An induction magnetic component includes a magnetic core, an insulation matrix, and a winding, where the magnetic core is embedded in the insulation matrix, and the magnetic core is of a ring structure. In addition, the insulation matrix includes a first end face and a second end face that are disposed back to back, a part of the winding penetrates the insulation matrix in a direction from the first end face to the second end face, and the winding is wound around the magnetic core. In the induction magnetic component provided, the magnetic core is embedded in the insulation matrix, and the winding is wound around the magnetic core by penetrating the insulation matrix, so that a height of the induction magnetic component can be greatly reduced while meeting a use requirement for the induction magnetic component.

### CROSS-REFERENCE TO RELATED APPLICATION

This application claims priority to Chinese Patent Application No. 202410383074.1, filed on Mar. 29, 2024, which is hereby incorporated by reference in its entirety.

### TECHNICAL FIELD

The embodiments relate to the field of energy technologies, and to an embedded induction magnetic component, a transformer, and a power supply device.

### BACKGROUND

A transformer is a key component in a power supply device for implementing a function of the power supply device, and may drive a switch transistor in the power supply device based on a principle of electromagnetic induction, to convert a direct current voltage into a high-frequency alternating current voltage through a switch operation of the switch transistor to supply power to a power-consuming device, thereby implementing the power supply function of the power supply device.

As an induction magnetic component, the transformer includes a magnetic core and a winding. Currently, due to a limitation of a conventional manufacturing process, it is difficult to reduce a height of the transformer in the power supply device to a small value. As a result, the transformer can be used only in a side with large height space of a main power board of the power supply device, which is not conducive to improving power density of a power supply system.

Therefore, how to reduce a height of the transformer while meeting an application requirement of the transformer has become a difficult problem to be urgently resolved by a person skilled in the art.

### SUMMARY

The embodiments provide an embedded induction magnetic component, a transformer, and a power supply device, to reduce a height of the induction magnetic component, thereby helping improve power density of the power supply device.

According to a first aspect, the embodiments provide an embedded induction magnetic component, including a magnetic core, an insulation matrix, and a winding, where the magnetic core is embedded in the insulation matrix, and the magnetic core is of a ring structure; and the insulation matrix includes a first end face and a second end face that are disposed back to back, a part of the winding penetrates the insulation matrix in a direction from the first end face to the second end face, and the winding is wound around the magnetic core. In the induction magnetic component provided in the embodiments, the magnetic core is embedded in the insulation matrix, and the winding is wound around the magnetic core by penetrating the insulation matrix, so that a height of the induction magnetic component can be greatly reduced while meeting a use requirement for the induction magnetic component.

In a possible implementation of the embodiments, the winding may be obtained through processing by using a printed circuit board (PCB) molding process. For example, the winding includes a plurality of connection parts and a plurality of through parts, the plurality of connection parts are separately disposed on two sides of the insulation matrix in the direction from the first end face to the second end face, the plurality of through parts all penetrate the insulation matrix, and the plurality of through parts are sequentially connected through the plurality of connection parts, to achieve an effect that the winding is wound around the magnetic core. In this way, height space outside the insulation matrix that is occupied by the winding can be small by controlling thicknesses of the plurality of connection parts of the winding, thereby helping reduce the height of the entire induction magnetic component.

In a possible implementation of the embodiments, the induction magnetic component further includes a first insulation layer and a second insulation layer, the first insulation layer covers the first end face of the insulation matrix, and the second insulation layer covers the second end face of the insulation matrix; and a part of the plurality of connection parts are located on a surface that is of the first insulation layer and that is away from the insulation matrix, and the other part of the plurality of connection parts are located on a surface that is of the second insulation layer and that is away from the insulation matrix. In this way, heights of the insulation matrix, the first insulation layer, the second insulation layer, and the like may be adjusted while ensuring electrical isolation between the magnetic core and the winding, thereby helping reduce the height of the induction magnetic component.

In a possible implementation of the embodiments, the induction magnetic component further includes a third insulation layer and a fourth insulation layer, the connection part disposed on the first end face is located between the insulation matrix and the third insulation layer, and the connection part disposed on the second end face is located between the insulation matrix and the fourth insulation layer. In this way, a creepage distance and an electric gap between connection parts located on a same side of the insulation matrix may be reduced, thereby reducing a board area occupied by the induction magnetic component, and further improving power density of a device in which the induction magnetic component is used.

In a possible implementation of the embodiments, the induction magnetic component further includes a first surface solder mask layer and a second surface solder mask layer, the first surface solder mask layer covers the third insulation layer, and the second surface solder mask layer covers the fourth insulation layer. In this way, performance of the induction magnetic component can be effectively improved, such as insulation, moisture-proof, leakage-proof, shockproof, dust-proof, anti-corrosion, anti-aging, electrical corona resistance, and high and low temperature resistance.

In a possible implementation of the embodiments, the induction magnetic component further includes a plurality of pins, and each of the pins is connected to the winding through a through part. In this way, the winding of the induction magnetic component may be led to the outside of the induction magnetic component through a corresponding pin, thereby facilitating connection between the winding and another component.

In a possible implementation of the embodiments, the plurality of pins are all located on a side that is of the first surface solder mask layer and that is away from the third insulation layer. In this way, the winding can be conveniently connected to another component.

In the embodiments, the magnetic core may be of a closed ring structure, or may be of a non-closed ring structure. The magnetic core may be designed based on a use requirement of a specific application scenario. For example, in a possible implementation of the embodiments, the magnetic core includes one or more air gaps, to adjust an excitation inductance of the magnetic core.

According to a second aspect, the embodiments further provide a transformer, including a magnetic core, an insulation matrix, a primary-side winding, and a secondary-side winding, where the magnetic core is embedded in the insulation matrix, and the magnetic core is of a ring structure; the insulation matrix includes a first end face and a second end face that are disposed back to back, a part of the primary-side winding penetrates the insulation matrix in a direction from the first end face to the second end face, and the primary-side winding is wound around the magnetic core; and a part of the secondary-side winding penetrates the insulation matrix in the direction from the first end face to the second end face, and the secondary-side winding is wound around the magnetic core. In the transformer provided in the embodiments, the magnetic core is embedded in the insulation matrix, and the primary-side winding and the secondary-side winding are wound around the magnetic core by penetrating the insulation matrix, so that a height of the transformer can be greatly reduced while meeting a use requirement for the transformer.

In a possible implementation of the embodiments, the primary-side winding and the secondary-side winding may be obtained through processing by using a PCB molding process. For example, the primary-side winding includes a plurality of primary-side connection parts and a plurality of primary-side through parts, the plurality of primary-side connection parts are separately disposed on two sides of the insulation matrix in the direction from the first end face to the second end face, the plurality of primary-side through parts all penetrate the insulation matrix, and the plurality of primary-side through parts are sequentially connected through the plurality of primary-side connection parts, to achieve an effect that the primary-side winding is wound around the magnetic core. A manner of disposing the secondary-side winding is similar to that of the primary-side winding. For example, the secondary-side winding includes a plurality of secondary-side connection parts and a plurality of secondary-side through parts, the plurality of secondary-side connection parts are separately disposed on two sides of the insulation matrix in the direction from the first end face to the second end face, the plurality of secondary-side through parts all penetrate the insulation matrix, and the plurality of secondary-side through parts are sequentially connected through the plurality of secondary-side connection parts, to achieve an effect that the secondary-side winding is wound around the magnetic core. In this way, height space outside the insulation matrix that is occupied by the primary-side winding and the secondary-side winding can be small by controlling thicknesses of the plurality of primary-side connection parts of the primary-side winding and the plurality of secondary-side connection parts of the secondary-side winding, thereby help to reduce the height of the entire transformer.

In a possible implementation of the embodiments, the transformer further includes a first insulation layer and a second insulation layer, the first insulation layer covers the first end face of the insulation matrix, and the second insulation layer covers the second end face of the insulation matrix; a part of the plurality of primary-side connection parts are located on a surface that is of the first insulation layer and that is away from the insulation matrix, and the other part of the plurality of primary-side connection parts are located on a surface that is of the second insulation layer and that is away from the insulation matrix; and a part of the plurality of secondary-side connection parts are located on the surface that is of the first insulation layer and that is away from the insulation matrix, and the other part of the plurality of secondary-side connection parts are located on the surface that is of the second insulation layer and that is away from the insulation matrix. In this way, heights of the insulation matrix, the first insulation layer, the second insulation layer, and the like may be adjusted while electrical isolation between the magnetic core and the primary-side winding and the secondary-side winding is ensured, thereby helping reduce the height of the transformer.

In a possible implementation of the embodiments, the transformer further includes a third insulation layer and a fourth insulation layer, the primary-side connection part disposed on the first end face is located between the insulation matrix and the third insulation layer, and the primary-side connection part disposed on the second end face is located between the insulation matrix and the fourth insulation layer; and the secondary-side connection part disposed on the first end face is located between the insulation matrix and the third insulation layer, and the secondary-side connection part disposed on the second end face is located between the insulation matrix and the fourth insulation layer. In this way, a creepage distance and an electric gap between the primary-side connection part and the secondary-side connection part that are located on a same side of the insulation matrix may be reduced, thereby reducing a board area occupied by the transformer, and further improving power density of the transformer.

In a possible implementation of the embodiments, the transformer further includes a first surface solder mask layer and a second surface solder mask layer, where the first surface solder mask layer covers the third insulation layer, and the second surface solder mask layer covers the fourth insulation layer. In this way, performance of the transformer can be effectively improved, such as insulation, moisture-proof, leakage-proof, shockproof, dust-proof, anti-corrosion, anti-aging, electrical corona resistance, and high and low temperature resistance.

In a possible implementation of the embodiments, the transformer further includes a plurality of first pins and a plurality of second pins, each first pin is connected to the primary-side winding through a primary-side through part, and each second pin is connected to the primary-side winding through a secondary-side through part. In this way, the primary-side winding and the secondary-side winding of the transformer may be led to the outside of the transformer through corresponding pins, thereby facilitating connection between the primary-side winding and the secondary-side winding and another component.

In a possible implementation of the embodiments, the plurality of first pins and the plurality of second pins are all located on a side that is of the first surface solder mask layer and that is away from the third insulation layer. In this way, the primary-side winding and the secondary-side winding can be conveniently connected to another component.

In a possible implementation of the embodiments, the transformer includes one primary-side winding and one secondary-side winding. In this way, the transformer can be used to drive one load.

In another possible implementation of the embodiments, the transformer includes one primary-side winding, a plurality of secondary-side windings, and a plurality of fifth insulation layers, secondary-side connection parts that are of the plurality of secondary-side windings and that are located on a same side of the insulation matrix are located in different layer structures, and one fifth insulation layer is disposed between layer structures in which secondary-side connection parts that are of any two adjacent secondary-side windings and that are located on the same side of the insulation matrix are located. In this way, each secondary-side winding of the transformer may be connected to one load, to achieve an effect that one transformer drives a plurality of loads.

In the embodiments, the magnetic core may be of a closed ring structure, or may be of a non-closed ring structure. The magnetic core may be designed based on a use requirement of a specific application scenario. For example, in a possible implementation of the embodiments, the magnetic core includes one or more air gaps, to adjust an excitation inductance of the magnetic core.

A material of the magnetic core is not limited. For example, the magnetic core may be made of a magnetic material like a ferrite, a metal magnetic powder core, a nanocrystalline strip, an amorphous strip, or a silicon steel sheet, so that the magnetic core can be configured to conduct an alternating magnetic flux.

According to a third aspect, the embodiments further provide a power supply device, including a main power board, a switch transistor, and the transformer in the second aspect, where the main power board includes a first surface and a second surface that are disposed back to back, the switch transistor is disposed on the first surface, and the transformer is disposed on the first surface or the second surface. The transformer provided in the embodiments has a small height. Therefore, a disposing position of the transformer on the main power board is flexible, and power density of the power supply device is high.

### BRIEF DESCRIPTION OF DRAWINGS

FIG. 1 is a diagram of an architecture of a power supply network according to an embodiment;

FIG. 2 is a diagram of an operating principle of a transformer according to an embodiment;

FIG. 3 is a diagram of a structure of a transformer according to an embodiment;

FIG. 4 is a diagram of an assembling structure of a magnetic core and an insulation matrix of a transformer according to an embodiment;

FIG. 5 is a diagram of a structure in which insulation layers are disposed on two end faces of an insulation matrix of the structure shown in FIG. 4;

FIG. 6 is an A-A sectional view of the structure shown in FIG. 5;

FIG. 7 is a diagram of a structure in which metal layers are disposed on two end faces of the structure shown in FIG. 5;

FIG. 8 is a B-B sectional view of the structure shown in FIG. 7;

FIG. 9 is a diagram of a structure after a primary-side winding and a secondary-side winding are formed based on the structure shown in FIG. 7;

FIG. 10 is a C-C sectional view of the structure shown in FIG. 9;

FIG. 11 is a diagram of a structure in which insulation layers are disposed on two end faces of the structure shown in FIG. 9;

FIG. 12 is a D-D sectional view of the structure shown in FIG. 11;

FIG. 13 is a diagram of another structure of a transformer according to an embodiment;

FIG. 14 is an E-E sectional view of the transformer shown in FIG. 13;

FIG. 15 is an F-direction view of the transformer shown in FIG. 13; and

FIG. 16 is a diagram of a structure of a power supply device according to an embodiment.

### DETAILED DESCRIPTION OF EMBODIMENTS

To make the objectives, solutions, and advantages clearer, the following further describes the embodiments in detail with reference to the accompanying drawings. However, example implementations can be implemented in a plurality of forms, and should not be construed as being limited to the implementations described herein. Identical reference numerals in the accompanying drawings denote identical or similar structures. Therefore, repeated description thereof is omitted. Expressions of positions and directions in embodiments are described by using the accompanying drawings as an example. However, changes may be also made as required, and all the changes fall within the scope of the embodiments. The accompanying drawings in embodiments are merely used to illustrate relative position relationships and do not represent an actual scale.

It should be noted that specific details are set forth in the following descriptions for ease of understanding the embodiments. However, the embodiments can be implemented in a plurality of manners different from those described herein, and a person skilled in the art can make similar inferences without departing from the connotation of the embodiments. Therefore, the embodiments are not limited to the following specific implementations.

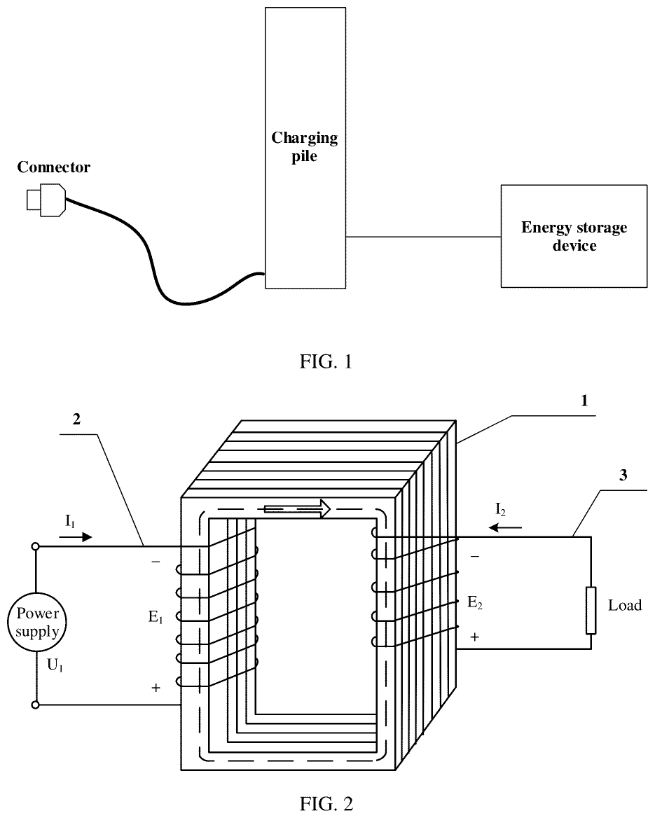

In the embodiments, a specific type of an induction magnetic component is not limited. For example, the induction magnetic component may be various magnetic components that implement functions of the induction magnetic component based on a principle of electromagnetic induction, for example, a transformer. For case of understanding the induction magnetic component provided in the embodiments, the following uses a transformer as an example for description. The transformer may be used in a scenario like an energy storage system, a photovoltaic power generation system, an optical storage system, or a charging network. For example, the transformer may be used in a power supply device like an uninterruptible power supply (UPS), a photovoltaic inverter, a charging pile, or an on board charger (OBC). A charging network scenario is used as an example. As shown in FIG. 1, FIG. 1 is a diagram of an architecture of a charging network according to an embodiment. The charging network includes a charging pile and an energy storage device. The charging pile is electrically connected to the energy storage device through a cable, and the energy storage device may supply electric energy stored in the energy storage device to the charging pile. The charging pile has a connector, and the connector may be connected to a powered device (like a vehicle), to charge the powered device.

The transformer works based on the principle of electromagnetic induction. FIG. 2 is a diagram of a working principle of the transformer according to an embodiment. Main components of the transformer are a magnetic core 1 and windings wound on two sides of the magnetic core 1. The two windings that are insulated from each other and have different numbers of turns are separately sleeved on the magnetic core 1, and there is only magnetic coupling but no electrical connection between the two windings. A winding connected to a power supply U1 is referred to as a primary-side winding 2, and a winding connected to a load is referred to as a secondary-side winding 3. After an alternating current voltage U1 of the power supply is added to the primary-side winding 2, a current I1 passes through the winding, and an alternating flux ¢ of a same frequency as U1 is generated in the magnetic core 1. According to the principle of electromagnetic induction, electromotive forces E1 and E2 are respectively induced in the two windings. A relationship between the electromotive force E1, the electromotive force E2, the alternating flux, the primary-side winding 2, and the secondary-side winding 3 is shown in a formula [1] and a formula [2].

$${E}_{1} = - {N}_{1} \frac{d ϕ}{d t} \qquad Formula ( 1 )$$

$${E}_{2} = - {N}_{2} \frac{d ϕ}{d t} \qquad Formula ( 2 )$$

In the foregoing formulas, “-” indicates that an induced electromotive force always prevents changing of a flux, N1 is a quantity of turns of the primary-side winding, and N2 is a quantity of turns of the secondary-side winding.

It can be understood that, if the load is connected to the secondary-side winding 3, under a function of the electromotive force E2, a current I2 flows through the load, thereby implementing electric energy transmission. It can be understood from the foregoing formula that magnitudes of induced electromotive forces of the primary-side winding 2 and the secondary-side winding 3 are in direct proportion to a quantity of turns of the windings. Therefore, the voltage can be changed by changing the quantity of turns of the primary-side winding 2 and the quantity of turns of the secondary-side winding 3. This is the basic working principle of the transformer.

Currently, a conventional transformer can be disposed in two types. In one type, a winding is wound on a magnetic core in a manner of winding, and there may be two implementations: the winding is directly wound around the magnetic core, and the winding is wound around a framework structure and then assembled on the magnetic core. In the other type, a winding of the transformer is obtained by processing a printed circuit board (PCB) through a molding process, and then a magnetic core is fastened on two sides of the printed circuit board. Although preparation techniques of the foregoing two types of conventional transformers are mature, due to a limitation of a structure of the transformer, it is difficult to reduce a height of the transformer to a small value. As a result, the transformer can only be disposed on a side with large height space of a main power board of a power supply device, which is not conducive to improving power density of the power supply device.

In view of this, an induction magnetic component provided in the embodiments is disposed in an embedded manner. A magnetic core is embedded in an insulation matrix, and electrical isolation between the magnetic core and a winding and a forming manner of the winding are both based on a PCB molding process, so that a height of the induction magnetic component can be greatly reduced while meeting a use requirement for the induction magnetic component, thereby helping improve power density of a power supply device in which the induction magnetic component is used. To facilitate understanding of the induction magnetic component provided in the embodiments, the following still uses a transformer as an example to describe the transformer in detail with reference to specific embodiments.

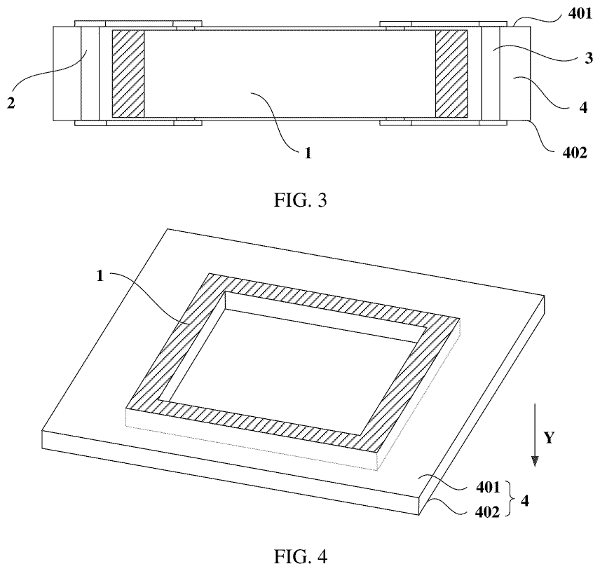

FIG. 3 is a diagram of a structure of a transformer according to an embodiment. The transformer includes a magnetic core 1, an insulation matrix 4, a primary-side winding 2, and a secondary-side winding 3. The magnetic core 1 is embedded in the insulation matrix 4, the insulation matrix 4 includes a first end face 401 and a second end face 402 that are disposed back to back, a part of the primary-side winding 2 penetrates the insulation matrix 4 in a direction from the first end face 401 to the second end face 402 and is wound around the magnetic core 1, and a part of the secondary-side winding 3 penetrates the insulation matrix 4 in the direction from the first end face 401 to the second end face 402 and is wound around the magnetic core 1.

In the embodiments, a type of the magnetic core 1 is not limited. For example, the magnetic core 1 may be made of a magnetic material like a ferrite, a metal magnetic powder core, a nanocrystalline strip, an amorphous strip, or a silicon steel sheet, so that the magnetic core 1 can be configured to conduct an alternating magnetic flux.

To facilitate understanding of the transformer provided in the embodiments, the following describes a specific structure of the transformer with reference to a preparation process of the transformer.

FIG. 4 is a diagram of an assembling structure of the magnetic core 1 and the insulation matrix 4 of the transformer according to an embodiment. In the embodiments, the magnetic core 1 may be of a ring structure. The ring structure may be a rectangular ring shown in FIG. 4, or be a regular ring like a circular ring or an elliptic ring, or may be another irregular ring. In addition, the magnetic core 1 may be of a closed ring structure, or may be of a non-closed ring structure. The magnetic core 1 may be designed based on a use requirement of a specific application scenario. For example, the magnetic core 1 may include an air gap, there may be one or more air gaps, and the air gap may be disposed at any position of the magnetic core 1, to adjust an excitation inductance of the magnetic core 1. Therefore, based on the foregoing basic structure form of the magnetic core 1, a specific structure of the magnetic core 1 may be disposed based on a use requirement of a specific application scenario.

In addition, in a Y direction in FIG. 4, that is, in a height direction of the transformer, a thickness of the magnetic core 1 may be as small as possible on the basis that a requirement for the magnetic core 1 to conduct an alternating flux is met. This may help reduce a height of the entire transformer.

In the embodiments, a material of the insulation matrix 4 is not limited. For example, the insulation matrix 4 may be an insulation material with a high dielectric strength and a high thermal conductivity, for example, epoxy resin, to meet an electrical isolation requirement of the magnetic core 1 and further facilitate heat dissipation for the magnetic core 1.

It should be noted that, in the embodiments, the magnetic core 1 may be embedded in the insulation matrix 4 in a plurality of manners. For example, the magnetic core 1 and the insulation matrix 4 may be integrally formed through an injection molding process, or the insulation matrix 4 may be provided with an accommodating groove, and the magnetic core 1 is accommodated in the accommodating groove.

Still refer to FIG. 4. In the embodiments, one end face of the magnetic core 1 may be coplanar with the first end face 401, and another end face of the magnetic core 1 may be coplanar with the second end face 402. This helps reduce a size of the transformer in the height direction.

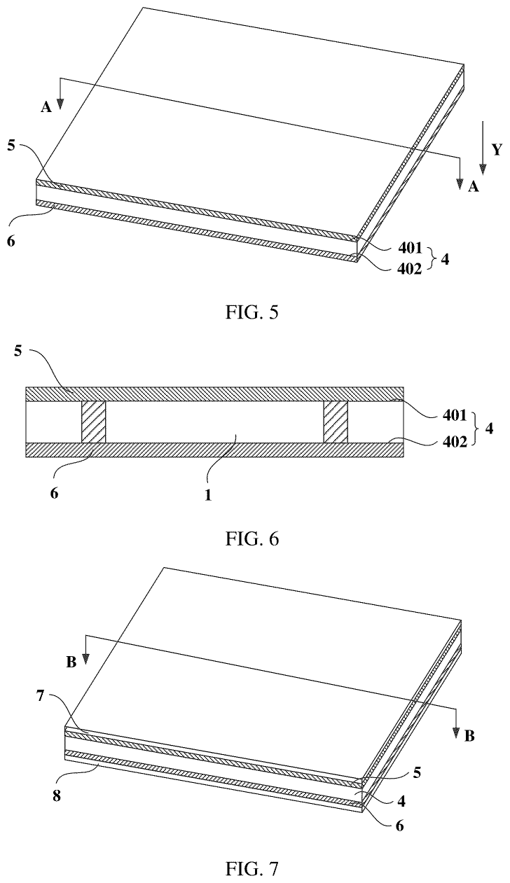

In addition, to implement electrical isolation between the magnetic core 1 and the windings, after the magnetic core 1 is embedded in the insulation matrix 4, insulation layers may be further disposed on the first end face 401 and the second end face 402 of the insulation matrix 4. During specific implementation, refer to FIG. 5. FIG. 5 is a diagram of a structure in which insulation layers are disposed on the two end faces of the insulation matrix 4 of the structure shown in FIG. 4. The transformer further includes a first insulation layer 5 and a second insulation layer 6. In addition, refer to FIG. 6. FIG. 6 is an A-A sectional view of the structure shown in FIG. 5. As shown in FIG. 6, the first insulation layer 5 covers the first end face 401 of the insulation matrix 4, and the second insulation layer 6 covers the second end face 402 of the insulation matrix 4. In the embodiments, materials of the first insulation layer 5 and the second insulation layer 6 are not limited. For example, the material may include glass fibers and epoxy resin, to meet an electrical isolation requirement of the magnetic core 1 and further improve structural reliability of the transformer. In addition, in the embodiments, the two end faces of the magnetic core 1 are respectively flush with the first end face 401 and the second end face 402 of the insulation matrix 4, and the insulation layers are respectively disposed on the first end face 401 and the second end face 402 of the insulation matrix 4. In this way, an electrical isolation effect of the magnetic core 1 can be ensured, and heights of the foregoing layer structures of the transformer can be controlled. This helps reduce the height of the transformer.

It may be understood that, in a possible embodiment of the embodiments, the magnetic core 1 may alternatively be completely wrapped by the insulation matrix 4. In this case, the first insulation layer 5 and the second insulation layer 6 may be omitted. The magnetic core 1 may still be electrically isolated, and it is possible to reduce an overall height of the transformer by controlling a height of the insulation matrix 4 and a height of the magnetic core 1.

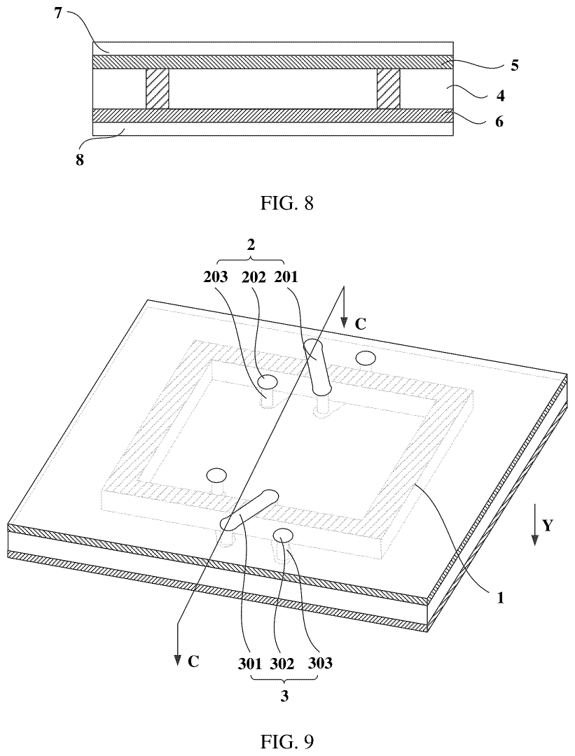

As described above, the winding of the transformer provided in the embodiments is obtained through processing by using a PCB molding process. The PCB can include an insulation layer and a metal layer that are stacked, and the metal layer may be etched with a cable used to implement an electrical connection. In addition, cables of different metal layers may be electrically connected through a via that penetrate the insulation layer. Based on this, each winding may be formed by connecting a metal cable and a via in the embodiments. Therefore, after the foregoing electrical isolation design of the magnetic core 1 is completed, a metal layer may be disposed on each insulation layer. During specific implementation, refer to FIG. 7. FIG. 7 is a diagram of a structure in which metal layers are disposed on the two end faces of the structure shown in FIG. 5. In addition, refer to FIG. 8. FIG. 8 is a B-B sectional view of the structure shown in FIG. 7. A first metal layer 7 is disposed on a surface that is of the first insulation layer 5 and that is away from the insulation matrix 4, and a second metal layer 8 is disposed on a surface that is of the second insulation layer 6 and that is away from the insulation matrix 4. The first metal layer 7 and the first insulation layer 5 may be, but are not limited to, connected through bonding or crimping. Similarly, the second metal layer 8 and the second insulation layer 6 may be, but are not limited to, connected through bonding or crimping.

In addition, in the embodiments, materials of the first metal layer 7 and the second metal layer 8 are not limited. For example, the first metal layer 7 and the second metal layer 8 may be copper foil, to meet a conductivity requirement, and further help reduce the height of the transformer.

Next, the primary-side winding 2 and the secondary-side winding 3 may be obtained through processing by using the foregoing PCB molding process. Refer to FIG. 9. FIG. 9 is a diagram of a structure after the primary-side winding 2 and the secondary-side winding 3 are formed based on the structure shown in FIG. 7. For example, the primary-side winding 2 includes a plurality of primary-side connection parts 201. A part of the plurality of primary-side connection parts 201 may be metal cables obtained by etching the first metal layer 7, and the other part of the plurality of primary-side connection parts 201 are metal cable obtained by etching the second metal layer 8. In other words, in the Y direction, that is, in a direction from the first end face to the second end face of the insulation matrix 4, the plurality of primary-side connection parts 201 are separately disposed on two sides of the insulation matrix 4. In addition, when the transformer includes the first insulation layer 5 and the second insulation layer 6, a part of the plurality of primary-side connection parts 201 are located on the surface that is of the first insulation layer 5 and that is away from the insulation matrix 4, and the other part of the plurality of primary-side connection parts 201 are located on the surface that is of the second insulation layer 6 and that is away from the insulation matrix 4. That is, the plurality of primary-side connection parts 201 located on the surface that is of the first insulation layer 5 and that is away from the insulation matrix 4 all protrude from the surface of the first insulation layer 5, and the plurality of primary-side connection parts 201 located on the surface that is of the second insulation layer 6 and that is away from the insulation matrix 4 all protrude from the surface of the second insulation layer 6.

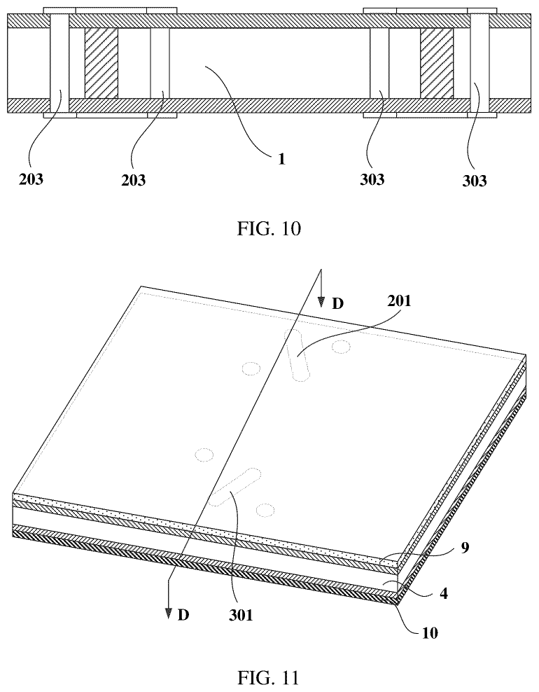

In addition, refer to FIG. 10. FIG. 10 is a C-C sectional view of the structure shown in FIG. 9. The primary-side winding 2 further includes a plurality of primary-side through parts 203, and the plurality of primary-side through parts 203 all penetrate the insulation matrix 4. In addition, refer to both FIG. 9 and FIG. 10. A part of the plurality of primary-side through parts 203 are located inside the ring of the magnetic core 1, and the other part of the plurality of primary-side through parts 203 are located outside the ring of the magnetic core 1. In the embodiments, the plurality of primary-side through parts 203 are sequentially connected through the plurality of primary-side connection parts 201. In this way, the primary-side winding 2 can be wound around the magnetic core 1.

As shown in FIG. 9, the primary-side winding 2 may further include a plurality of primary-side cable connectors 202, where the plurality of primary-side cable connectors 202 are all obtained by etching the first metal layer 7, and the plurality of primary-side cable connectors 202 are all located on a side that is of the first end face 401 of the insulation matrix 4 and that is away from the second end face 402. In the embodiments, the primary-side winding 2 may be connected to an external component through the primary-side cable connector 202, and each primary-side cable connector 202 may be connected to the primary-side connection part 201 through the primary-side through part 203.

It should be noted that a quantity of primary-side cable connectors 202 of the primary-side winding 2 is related to a disposing form of the primary-side winding 2 in a specific application scenario. For example, when the primary-side winding 2 includes a plurality of windings connected in series, the quantity of primary-side cable connectors 202 of the primary-side winding 2 may be three, four, five, or the like. When the primary-side winding 2 includes a plurality of windings connected in parallel or includes only one winding, the primary-side winding 2 may include two primary-side cable connectors 202.

A disposing manner of the secondary-side winding 3 is similar to that of the primary-side winding 2. For example, the secondary-side winding 3 includes a plurality of secondary-side connection parts 301, a part of the plurality of secondary-side connection parts 301 may be metal cables obtained by etching the first metal layer 7, and the other of the plurality of secondary-side connection parts 301 are metal cables obtained by etching the second metal layer 8. In other words, in the Y direction, the plurality of secondary-side connection parts 301 are separately disposed on the two sides of the insulation matrix 4. In addition, when the transformer includes the first insulation layer 5 and the second insulation layer 6, a part of the plurality of secondary-side connection parts 301 are located on the surface that is of the first insulation layer 5 and that is away from the insulation matrix 4, and the other part of the plurality of secondary-side connection parts 301 are located on the surface that is of the second insulation layer 6 and that is away from the insulation matrix 4. That is, the plurality of secondary-side connection parts 301 located on the surface that is of the first insulation layer 5 and that is away from the insulation matrix 4 all protrude from the surface of the first insulation layer 5, and the plurality of secondary-side connection parts 301 that are located on the surface that is of the second insulation layer 6 and that is away from the insulation matrix 4 all protrude from the surface of the second insulation layer 6.

Refer to FIG. 10. The secondary-side winding 3 further includes a plurality of secondary-side through parts 303, and the plurality of secondary-side through parts 303 all penetrate the insulation matrix 4. In addition, refer to both FIG. 9 and FIG. 10. A part of the plurality of secondary-side through parts 303 are located inside the ring of the magnetic core 1, and the other part of the plurality of secondary-side through parts 303 are located outside the ring of the magnetic core 1. In the embodiments, the plurality of secondary-side through parts 303 are sequentially connected through the plurality of secondary-side connection parts 301. In this way, the secondary-side winding 3 can be wound around the magnetic core 1.

In addition, as shown in FIG. 9, the secondary-side winding 3 further includes a plurality of secondary-side cable connectors 302, where the plurality of secondary-side cable connectors 302 are all obtained by etching the first metal layer 7, and the plurality of secondary-side cable connectors 302 are all located on the side that is of the first end face 401 of the insulation matrix 4 and that is away from the second end face 402. In the embodiments, the secondary-side winding 3 may be connected to an external component through the secondary-side cable connector 302, and each secondary-side cable connector 302 may be connected to the secondary-side connection part 301 through the secondary-side through part 303. In addition, a quantity of secondary-side cable connectors 302 of the secondary-side winding 3 is related to a disposing form of the secondary-side winding 3 in a specific application scenario. For example, when the secondary-side winding 3 includes a plurality of windings connected in series, the quantity of secondary-side cable connectors 302 of the secondary-side winding 3 may be three, four, five, or the like. When the secondary-side winding 3 includes a plurality of windings connected in parallel or includes only one winding, the secondary-side winding 3 may include two secondary-side cable connectors 302.

It should be noted that, in the embodiments, a quantity of turns of the primary-side winding 2 may be adjusted by adjusting the quantities of primary-side connection parts 201 and primary-side through parts 203 of the primary-side winding 2, and a quantity of turns of the secondary-side winding 3 may be adjusted by adjusting the quantities of secondary-side connection parts 301 and secondary-side through parts 303 of the secondary-side winding 3, so that the transformer meets a use requirement.

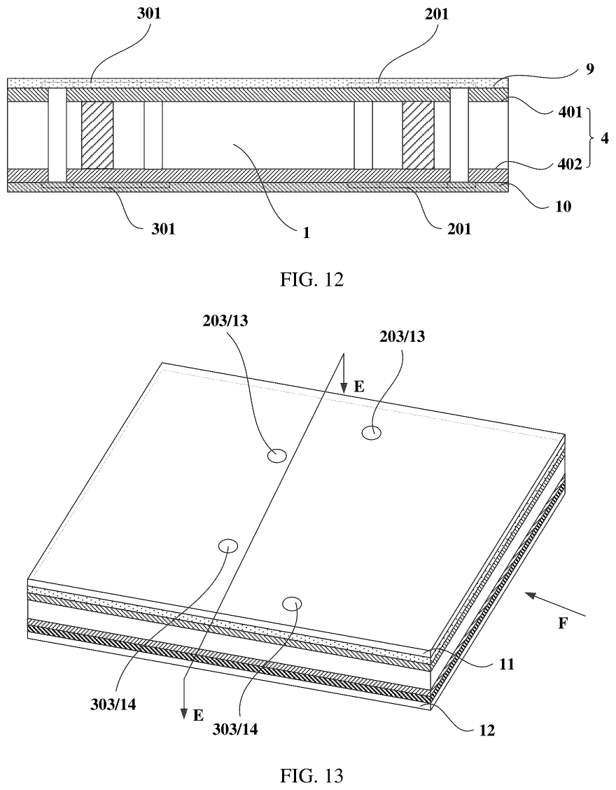

In the transformer provided in the embodiments, after the steps of preparing the primary-side winding 2 and the secondary-side winding 3 are completed, electrical isolation between the primary-side winding 2 and the secondary-side winding 3 may be further implemented by disposing an insulation layer. During specific implementation, refer to FIG. 11. FIG. 11 is a diagram of a structure in which insulation layers are disposed on the two end faces of the structure shown in FIG. 9. The transformer further includes a third insulation layer 9 and a fourth insulation layer 10. In addition, refer to FIG. 12. FIG. 12 is a D-D sectional view of the structure shown in FIG. 11. The third insulation layer 9 covers the primary-side connection part 201 and the secondary-side connection part 301 that are located on the side that is of the first end face 401 of the insulation matrix 4 and that is away from the second end face 402, and the fourth insulation layer 10 covers the primary-side connection part 201 and the secondary-side connection part 301 that are located on the side that is of the second end face 402 of the insulation matrix 4 and that is away from the first end face 401. Therefore, the primary-side connection part 201 disposed on the first end face 401 of the insulation matrix 4 is located between the insulation matrix 4 and the third insulation layer 9, the other part of the plurality of primary-side connection parts 201 disposed on the second end face 402 of the insulation matrix 4 are located between the insulation matrix 4 and the fourth insulation layer 10, the secondary-side connection part 301 disposed on the first end face 401 of the insulation matrix 4 is located between the insulation matrix 4 and the third insulation layer 9, and the secondary-side connection part 301 disposed on the second end face 402 of the insulation matrix 4 is located between the insulation matrix 4 and the fourth insulation layer 10, to achieve an effect that the third insulation layer 9 and the fourth insulation layer 10 cover the primary-side winding 2 and the secondary-side winding 3, thereby implementing electrical isolation between the primary-side winding 2 and the secondary-side winding 3.

In the embodiments, the third insulation layer 9 and the fourth insulation layer 10 may be disposed with reference to the first insulation layer 5 and the second insulation layer 6. Details are not described herein.

It should be noted that the insulation layers are disposed on the surfaces of the primary-side connection part 201 and the secondary-side connection part 301 that are located on the same side of the insulation matrix 4, which is beneficial to reduce a creepage distance and an electric gap between the primary-side connection part 201 and the secondary-side connection part 301 that are located on the same side of the insulation matrix 4, thereby helping reduce a board area occupied by the transformer and further improving power density of the transformer. In addition, when there is no insulation requirement or a low insulation requirement for the primary-side winding 2 and the secondary-side winding 3, the third insulation layer 9 and the fourth insulation layer 10 may be omitted, thereby simplifying a structure of the transformer and further reducing the height of the transformer.

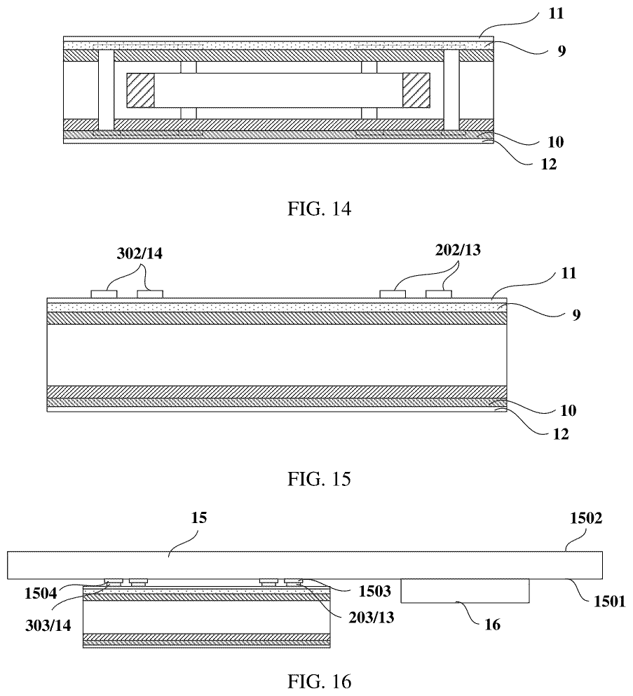

After the foregoing electrical isolation design of the windings of the transformer is completed, the surfaces of the third insulation layer 9 and the fourth insulation layer 10 may be coated with solder mask layers. During specific implementation, refer to FIG. 13. FIG. 13 is a sectional view of another structure of the transformer according to an embodiment. The transformer includes a first surface solder mask layer 11 and a second surface solder mask layer 12. In addition, refer to FIG. 14. FIG. 14 is an E-E sectional view of the transformer shown in FIG. 13. The first surface solder mask layer 11 covers the third insulation layer 9, and the second surface solder mask layer 12 covers the fourth insulation layer 10. In the embodiments, materials of both the first surface solder mask layer 11 and the second surface solder mask layer 12 may be conformal coating that can effectively improve performance of the transformer, such as insulation, moisture-proof, leakage-proof, shockproof, dust-proof, anti-corrosion, anti-aging, electrical corona resistance, and high and low temperature resistance.

It can be understood from the foregoing descriptions of the working principle of the transformer that the plurality of primary-side cable connectors 202 of the primary-side winding 2 may be configured to connect to a power supply, and the plurality of secondary-side windings 3 of the secondary-side winding 3 may be configured to connect to a load. In order to connect the primary-side winding 2 and the secondary-side winding 3 to another component, as shown in FIG. 13, the transformer may further include a plurality of first pins 13 and a plurality of second pins 14, where each first pin 13 may be connected to the primary-side winding 2 through a primary-side through part 203, and each second pin 14 may be connected to the secondary-side winding 3 through a secondary-side through part 303.

In addition, refer to FIG. 15. FIG. 15 is an F-direction view of the transformer shown in FIG. 13. In the transformer, the plurality of first pins 13 and the plurality of second pins 14 are all located on a side that is of the first surface solder mask layer 11 and that is away from the third insulation layer 9. In addition, when the primary-side winding 2 includes the plurality of primary-side cable connectors 202, the plurality of first pins 13 may be connected to the plurality of primary-side cable connectors 202 in a one-to-one correspondence, to connect each first pin 13 to a corresponding primary-side through part 203. Similarly, when the secondary-side winding 3 includes the plurality of secondary-side cable connectors 302, the plurality of second pins 14 are connected to the plurality of secondary-side cable connectors 302 in a one-to-one correspondence, to connect each second pin 14 to a corresponding secondary-side through part 303.

It should be noted that, in the embodiments, the sequence of the steps of preparing the first surface solder mask layer 11 and the second surface solder mask layer 12 and the second pins 14 is not limited. That is, the first surface solder mask layer 11 and the second surface solder mask layer 12 may be formed on the surface of the transformer first, and then the plurality of primary-side cable connectors 202 and the plurality of secondary-side cable connectors 302 are connected to the corresponding pins. Alternatively, the sequence of the steps may be exchanged.

In addition, in a possible embodiment, a part of the plurality of primary-side cable connectors 202 may be further located on the side that is of the first surface solder mask layer 11 and that is away from the third insulation layer 9, and a part of the plurality of secondary-side cable connectors 302 may be located on the side that is of the first surface solder mask layer 11 and that is away from the third insulation layer 9. In this way, the steps of preparing the first pins 13 and the second pins 14 may be omitted, thereby helping improve efficiency of preparing the transformer.

In the foregoing embodiment, the plurality of primary-side cable connectors 202 and the plurality of secondary-side cable connectors 302 are all located on the side that is of the first end face 401 of the insulation matrix 4 and that is away from the second end face 402, and the plurality of first pins 13 and the plurality of second pins 14 are all located on the side that is of the first surface solder mask layer 11 and that is away from the third insulation layer 9. In this way, the primary-side winding 2 and the secondary-side winding 3 can be conveniently connected to another component. Specific positions of the plurality of primary-side cable connectors 202 and the plurality of secondary-side cable connectors 302 are not limited. For example, at least one of the plurality of primary-side cable connectors 202 may be located on a side that is of the first end face 401 of the insulation matrix 4 and that is away from the second end face 402, and at least one of the plurality of secondary-side cable connectors 302 may be located on the side that is of the first end face 401 of the insulation matrix 4 and that is away from the second end face 402. Disposing positions of the pins of the transformer may be adaptively adjusted based on disposing positions of the foregoing cable connectors.

In the foregoing embodiment, an example in which the transformer includes one primary-side winding 2 and one secondary-side winding 3 is used for description. Based on a design principle of the transformer provided in the embodiments, in some possible application scenarios, the transformer may alternatively include one primary-side winding 2 and a plurality of secondary-side windings 3, so that the transformer can simultaneously drive switch operations of a plurality of switch transistors.

It should be noted that, when the transformer includes the plurality of secondary-side windings 3, each secondary-side winding 3 may be disposed with reference to the secondary-side winding 3 in the foregoing embodiment, and secondary-side connection parts 301 that are of the plurality of secondary-side windings 3 and that are located on a same side of the insulation matrix 4 are located in different layer structures. In addition, the transformer further includes a plurality of fifth insulation layers. The fifth insulation layer may be disposed with reference to the first insulation layer 5 and the second insulation layer 6. Details are not described herein again. In this way, one fifth insulation layer is disposed between layer structures in which secondary-side connection parts 301 that are of any two adjacent secondary-side windings 3 and that are located on a same side of the insulation matrix 4 are located, so that electrical isolation of the secondary-side windings 3 can be implemented.

In the transformer provided in the embodiments, the magnetic core 1 is embedded in the insulation matrix 4, and the primary-side winding 2 and the secondary-side winding 3 are obtained through processing by using a PCB molding process. In this way, an application requirement of the transformer can be met, and the height of the transformer can be further greatly reduced. In a specific embodiment, the height of the transformer may be 3.0 mm or less.

The transformer provided in the foregoing embodiment may be used in various power supply devices. FIG. 16 is a diagram of a structure of a power supply device according to an embodiment. The power supply device may further include a main power board 15 and a switch transistor 16. The main power board 15 may include a first surface 1501 and a second surface 1502 that are disposed back to back, and the switch transistor 16 is disposed on the first surface 1501, that is, height space of a side that is of the first surface 1501 of the main power board 15 and that is away from the second surface 1502 is large. In addition, in the power supply device shown in FIG. 16, a transformer is also disposed on the first surface 1501 of the main power board 15, and a plurality of first pins 13 of the transformer may be soldered, through a solder like soldering tin, to a plurality of first pads 1503 disposed on the first surface 1501 of the main power board 15 in a one-to-one correspondence. In addition, a plurality of second pins 14 of the transformer may be soldered, through a solder like soldering tin, to a plurality of second pads 1504 disposed on the first surface 1501 of the main power board 15 in a one-to-one correspondence.

Because a height of the transformer provided in the embodiments is small, in some possible scenarios, the transformer may be alternatively disposed on the second surface 1502 of the main power board 15, such as a side of the main power board 15 with small height space. Therefore, a disposing position of the transformer provided in embodiments on the main power board 15 is flexible, which can help improve power density of the power supply device.

It may be understood that the foregoing describes a specific disposing manner of the induction magnetic component provided in the embodiments by using the transformer as an example. Based on this, another type of induction magnetic component may also be disposed in the foregoing embedded manner, and the induction magnetic component is not described herein, but it should be understood that the induction magnetic component falls within the scope of the embodiments.

The foregoing descriptions are merely specific implementations of the embodiments, but are not intended to limit their scope. Any variation or replacement readily figured out by a person skilled in the art shall fall within the scope of the embodiments.

1. An induction magnetic component, comprising:
a magnetic core having a ring structure;
an insulation matrix, wherein the insulation matrix comprises a first end face and a second end face that are disposed back to back and the magnetic core is embedded in the insulation matrix; and
a winding, wherein part of the winding penetrates the insulation matrix in a direction from the first end face to the second end face, and the winding is wound around the magnetic core.

2. The induction magnetic component according to claim 1, wherein the winding further comprises:
a plurality of connection parts separately disposed on two sides of the insulation matrix in the direction from the first end face to the second end face; and
a plurality of through parts that penetrates the insulation matrix and is sequentially connected through the plurality of connection parts.

3. The induction magnetic component according to claim 2, further comprising:
a first insulation layer covering the first end face of the insulation matrix; and
a second insulation layer covering the second end face of the insulation matrix, wherein a first part of the plurality of connection parts is located on a surface of the first insulation layer that is away from the insulation matrix, and a second part of the plurality of connection parts is located on a surface of the second insulation layer that is away from the insulation matrix.

4. The induction magnetic component according to claim 2, further comprising:
a third insulation layer; and
a fourth insulation layer, wherein the connection part disposed on the first end face is located between the insulation matrix and the third insulation layer, and the connection part disposed on the second end face is located between the insulation matrix and the fourth insulation layer.

5. The induction magnetic component according to claim 4, further comprising:
a first surface solder mask layer covering the third insulation layer; and
a second surface solder mask layer covering the fourth insulation layer.

6. The induction magnetic component according to claim 5, further comprising:
a plurality of pins, wherein each pin of the plurality of pins is connected to the winding through one through part of the plurality of through parts.

7. The induction magnetic component according to claim 6, wherein the plurality of pins is located on a side of the first surface solder mask layer that is away from the third insulation layer.

8. The induction magnetic component according to claim 1, wherein the magnetic core comprises one or more air gaps.

9. A transformer, comprising:
a magnetic core having a ring structure;
an insulation matrix, wherein the insulation matrix comprises a first end face and a second end face that are disposed back to back and the magnetic core is embedded in the insulation matrix,
a primary-side winding, wherein a part of the primary-side winding penetrates the insulation matrix in a direction from the first end face to the second end face and the primary-side winding is wound around the magnetic core; and
a secondary-side winding, wherein a part of the secondary-side winding penetrates the insulation matrix in the direction from the first end face to the second end face, and the secondary-side winding is wound around the magnetic core.

10. The transformer according to claim 9, wherein the primary-side winding further comprises:
a plurality of primary-side connection parts separately disposed on two sides of the insulation matrix in the direction from the first end face to the second end face and
a plurality of primary-side through parts that penetrates the insulation matrix, wherein the plurality of primary-side through parts is sequentially connected through the plurality of primary-side connection parts, and the secondary-side winding comprises:
a plurality of secondary-side connection parts separately disposed on the two sides of the insulation matrix in the direction from the first end face to the second end face; and
a plurality of secondary-side through parts that penetrates the insulation matrix and the plurality of secondary-side through parts is sequentially connected through the plurality of secondary-side connection parts.

11. The transformer according to claim 10, further comprising:
a first insulation layer, wherein the first insulation layer covers the first end face of the insulation matrix; and
a second insulation layer, wherein the second insulation layer covers the second end face of the insulation matrix, a first part of the plurality of primary-side connection parts is located on a surface of the first insulation layer that is away from the insulation matrix, a second part of the plurality of primary-side connection parts is located on a surface of the second insulation layer that is away from the insulation matrix a first part of the plurality of secondary-side connection parts is located on the surface of the first insulation layer that is away from the insulation matrix, and a second part of the plurality of secondary-side connection parts is located on the surface of the second insulation layer that is away from the insulation matrix.

12. The transformer according to claim 10, further comprising:
a third insulation layer; and
a fourth insulation layer, wherein the primary-side connection part disposed on the first end face is located between the insulation matrix and the third insulation layer, the primary-side connection part disposed on the second end face is located between the insulation matrix and the fourth insulation layer; the secondary-side connection part disposed on the first end face is located between the insulation matrix and the third insulation layer, and the secondary-side connection part disposed on the second end face is located between the insulation matrix and the fourth insulation layer.

13. The transformer according to claim 9, further comprising:
one primary-side winding; and
one secondary-side winding.

14. The transformer according to claim 10, further comprising:
one primary-side winding;
a plurality of secondary-side windings, wherein secondary-side connection parts are of the plurality of secondary-side windings located on a same side of the insulation matrix are located in different layer structures; and
a plurality of fifth insulation layers, wherein one fifth insulation layer is disposed between layer structures in which secondary-side connection parts of any two adjacent secondary-side windings are located on the same side of the insulation matrix.

15. A power supply device, comprising
a main power board comprising a first surface and a second surface that are disposed back to back,
a switch transistor disposed on the first surface; and
a transformer disposed on either the first surface or the second surface, wherein the transformer comprises:
a magnetic core having a ring structure;
an insulation matrix, wherein the insulation matrix comprises a first end face and a second end face that are disposed back to back and the magnetic core is embedded in the insulation matrix;
a primary-side winding, wherein a part of the primary-side winding penetrates the insulation matrix in a direction from the first end face to the second end face and the primary-side winding is wound around the magnetic core; and
a secondary-side winding, wherein a part of the secondary-side winding penetrates the insulation matrix in the direction from the first end face to the second end face, and the secondary-side winding is wound around the magnetic core.

16. The induction magnetic component of claim 1, wherein the ring structure is a rectangular ring.

17. The induction magnetic component of claim 1, wherein the ring structure is a circular ring.

18. The induction magnetic component of claim 1, wherein the ring structure is an elliptical ring.

19. The induction magnetic component of claim 1, wherein the ring structure is a closed ring structure.

20. The induction magnetic component of claim 1, wherein the ring structure is a non-closed ring structure.
